(19) United States
(12) Patent Application Publication
(10) Pub. No.: US 2007/0201743 A1
(43) Pub. Date: Aug. 30, 2007

(54) Methods and systems for identifying characteristics in a digital image

(75) Inventor: Ahmet Mufit Ferman, Vancouver, WA (US)

Correspondence Address: KRIEGER INTELLECTUAL PROPERTY, INC., P.O. BOX 1073, CAMAS, WA, 98607, US

(73) Assignee: Sharp Laboratories of America, Inc.

(21) Appl. No.: 11/365,067

(22) Filed: Feb. 28, 2006

(51) Int. Cl. G06K 9/00

(52) U.S. Cl. 382/168

(57) ABSTRACT

Embodiments of the present invention comprise methods and systems for identification of characteristics of an image.

### FIELD OF THE INVENTION

Embodiments of the present invention comprise methods and systems for identifying characteristics in a digital image.

### BACKGROUND

Many digital image processing enhancements that improve the visual quality of a digital image, often a scanned image of a document, rely on the accurate identification of different image regions in the digital image. Additionally, accurate detection of various regions in an image is critical in many compression processes. Image characteristics may be used in the identification of image regions.

### SUMMARY

Some embodiments of the present invention comprise systems and methods for identifying image characteristics by aggregating information from multiple histograms wherein each histogram corresponds to a segment of the image.

The foregoing and other objectives, features, and advantages of the invention will be more readily understood upon consideration of the following detailed description of the invention taken in conjunction with the accompanying drawings.

### BRIEF DESCRIPTION OF THE SEVERAL DRAWINGS

FIG. 1 is a diagram of embodiments of the present invention comprising feature information aggregation from segment histograms;

FIG. 2 a diagram showing an exemplary division of an input image into regions;

FIG. 3 is a plot showing an exemplary segment histogram;

FIG. 4 is a plot showing an exemplary segment histogram;

FIG. 5 is a diagram of embodiments of the present invention comprising feature information aggregation from segment histograms wherein said feature information comprises peak information;

FIG. 6 is a diagram of embodiments of the present invention comprising aggregation of peak information from segment histograms to identify image regions wherein image masks are generated for identified image regions;

FIG. 7 is a diagram showing an image comprising page background and local background regions;

FIG. 8 is a diagram of embodiments of the present invention comprising peak information aggregation from strip histograms; and

FIG. 9 is a diagram of embodiments of the present invention comprising a preprocessed input image and aggregation from segment histograms.

### DETAILED DESCRIPTION OF EXEMPLARY EMBODIMENTS

Embodiments of the present invention will be best understood by reference to the drawings, wherein like parts are designated by like numerals throughout. The figures listed above are expressly incorporated as part of this detailed description.

It will be readily understood that the components of the present invention, as generally described and illustrated in the figures herein, could be arranged and designed in a wide variety of different configurations. Thus, the following more detailed description of the embodiments of the methods and systems of the present invention is not intended to limit the scope of the invention, but it is merely representative of the presently preferred embodiments of the invention.

Elements of embodiments of the present invention may be embodied in hardware, firmware and/or software. While exemplary embodiments revealed herein may only describe one of these forms, it is to be understood that one skilled in the art would be able to effectuate these elements in any of these forms while resting within the scope of the present invention.

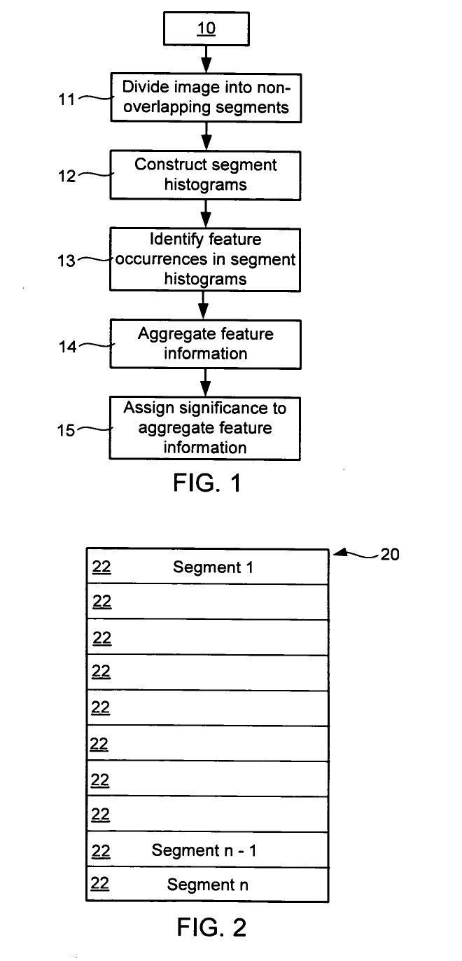

Some embodiments of the present invention comprise methods and systems for identifying image characteristics. Some embodiments of the present invention are shown in FIG. 1. An input image 10 is divided, at step 11, into n non-overlapping segments. FIG. 2 shows an exemplary division of an input image 20 into n segments 22.

In some embodiments of the present invention, the input image 10 may be a luminance image. A luminance image may be derived from a scan, such as a color scan of a color or a black-and-white document, or by other methods. In other embodiments of the present invention, the input image 10 may be a chromaticity image derived from a scan, such as a color scan of a color or a black-and-white document, or by other methods. In still other embodiments of the invention, the input image 10 may be a grayscale image such as one derived from a black-and-white scan of a color or a black-and-white document or by other methods.

The input image 10 is not limited to digital images resulting from a scanning operation. The digital input image 10 may be generated in electronic form (e.g., from a digital camera, a computer application, or another method). In some embodiments of the present invention, the input image 10 may be a single-channel digital image. In other embodiments of the invention, the input image 10 may be a multi-channel digital image. In some embodiments of the present invention, the input image 10 may be generated by processing a digital image to form a new, processed digital image. Some examples of such processing include, but are not limited to: thresholding, edge-strength determination, and edge-direction determination.

In some embodiments, the n segments may be of arbitrary shape. In some embodiments, all n segments may be the same shape and/or size. In some embodiments, the n segments may be different shapes.

In some embodiments, the segments may be strips. In some embodiments, n non-overlapping strips may each comprise an equal number of rows of the input image 10. In other embodiments, the n non-overlapping strips may not be the same size, in terms of number of rows. In some embodiments, the n non-overlapping strips may cover the input image 10 in its entirety. In some embodiments, the n non-overlapping strips may cover only a part of the input image 10.

In some embodiments of the present invention, the input image 10 may be divided into n non-overlapping blocks (i.e., the segments are blocks). These non-overlapping blocks may cover the input image 10 in its entirety or may cover only a part of the input image 10. These non-overlapping blocks may be the same size or they may differ in size.

In the embodiments shown in FIG. 1, division of the input image 10 into n non-overlapping segments, step 11, may be followed by the construction of segment histograms, step 12. A segment histogram may be constructed for each of the n image segments or some subset of the image segments. If the image segments are strips of the image, the segment histogram may be referred to as a strip histogram. If the image segments are blocks of the image, the segment histogram may be referred to as a block histogram.

In some embodiments of the method shown by FIG. 1, the segment histograms constructed at step 12, may each be one-dimensional histograms. Each bin in a segment histogram may show the number of pixels occurring in the corresponding image segment for which the pixels have the characteristic represented by the bin. For embodiments in which the input image 10 is a luminance image, the histogram bins may correspond to luminance values, and, in such embodiments, the histogram for a particular image segment would reflect how many times a luminance value occurs in the image segment. In other embodiments of the method shown by FIG. 1, the segment histograms constructed at step 12, may be multi-dimensional histograms where the dimensions may correspond to some combinations of dimensions of a multi-dimensional input image 10.

Occurrences of features in each of the segment histograms may be identified at step 13. Identification of occurrences of features may generate feature information describing the feature occurrence. The feature information from the segment histograms may be aggregated to form aggregate feature information at step 14. A significance value may be assigned to portions of the aggregate feature information at step 15. In some embodiments, image characteristics may be determined from the aggregate feature information. In some embodiments, image characteristics may be determined from the aggregate feature information in conjunction with the significance values.

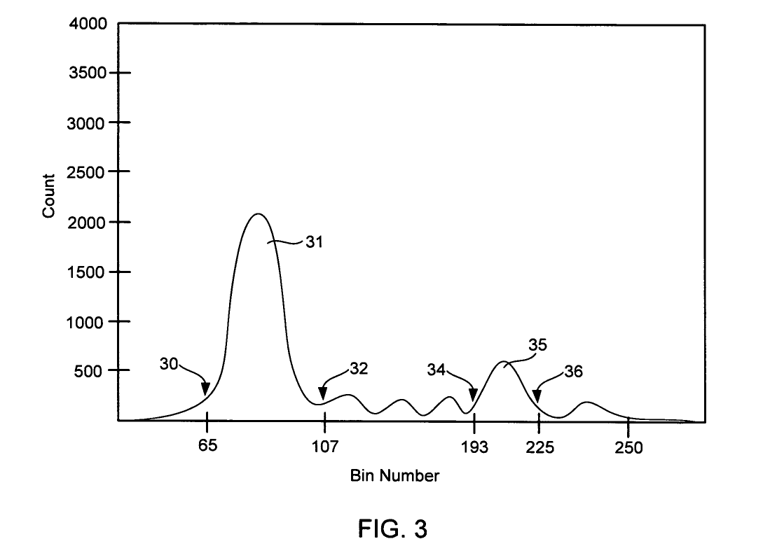

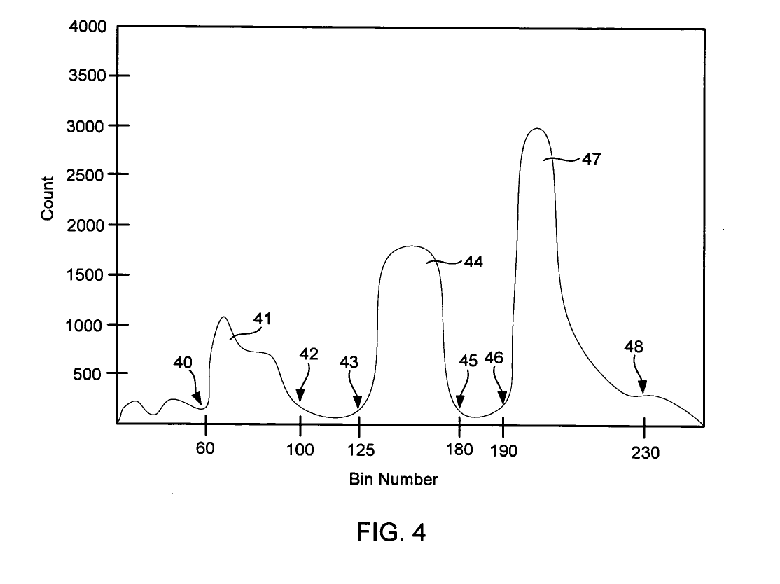

FIG. 3 and FIG. 4 show two, one-dimensional histograms, each representing the segment histogram of a segment of an image.

In some embodiments comprising the process shown by FIG. 1, the feature occurrences identified in step 13, may be identified by a starting bin and an ending bin, in the histogram, between which the feature occurs. This range of bin values between a feature starting bin and a feature ending bin may be referred to as a feature range or region of occurrence. Aggregation of the feature information at step 14 may comprise, in some embodiments, a page feature counter. In some embodiments, the page feature counter may be in the form of a page feature histogram. The page feature histogram may have bins corresponding to the bins of the segment histograms, wherein the bin counts in the page feature histogram may increment when the bin falls within the a feature range in a segment histogram. In such embodiments, the page feature histogram reflects the number of times a bin falls within a feature range in the input image 10.

In some embodiments comprising the method shown by FIG. 1, a feature range in the page feature histogram may be assigned a significance value, step 15. The significance value for a feature range, also referred to as the region of occurrence of a feature in the page feature histogram, may be related to the number of pixels in the image with values corresponding to the histogram bins included in the feature range. In some embodiments, the measure of the number of pixels may be a percentage. This percentage may be determined by the page histogram which, in some embodiments, may be constructed through the accumulation of the segment histograms.

In some embodiments of the method shown in FIG. 1, a feature range in the page feature histogram may be modified based on its significance value. The modification may be the normalization of the region in the page feature histogram. If an occurrence of a feature contains too few pixels, the region corresponding to that feature occurrence may be deemed insignificant.

In some embodiments, the regions of occurrence of the features in the page feature histogram may correspond to image characteristics. The image characteristics may be, but are not limited to, the color of uniform-color regions of the input image 10, the luminance of uniform-luminance regions of the input image 10, the color of large text regions in the input image 10, the luminance of large text regions in the input image.

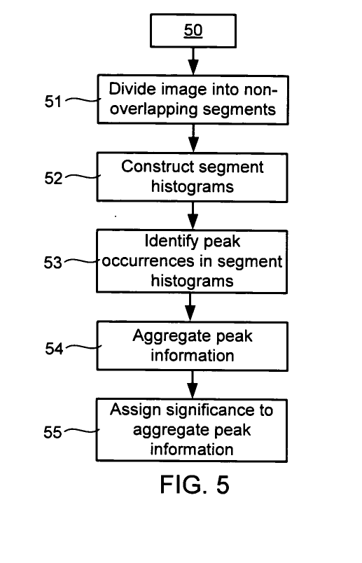

In an exemplary embodiment shown in FIG. 5, the histogram feature detected may be the occurrence of a peak in the segment histogram. A peak may correspond to a major population of image pixels with similar values in the image segment. A peak may be defined by a range of histogram bin values between which a local maximum occurs

In this exemplary embodiment, the input image 50 may be divided into n non-overlapping image segments, step 51. Segment histograms are constructed for the non-overlapping image segments, step 52. Peaks may be identified in the segment histograms, step 53. In some embodiments, identification of a peak may comprise identification of a starting bin and an ending bin in the segment histogram between which the peak occurs. Data identifying the starting bin and the ending bin in the segment histogram between which the peak occurs may be referred to as peak information in some embodiments. The peak information from the segment histograms may be aggregated to form aggregate peak information, step 54. Significance values may be assigned to the peaks in the aggregate peak information, step 55.

Any one of many possible peak detection methods may be employed to identify the peaks in the segment histograms. In some embodiments peak detection may comprise, but is not limited to, one of the following peak detection methodologies: thresholding, neural-network-based methods, fuzzy-logic-based methods, methods based on determining positive to negative zero crossings to represent the start of a peak, and maxima following such a zero crossing to represents the end of a peak, and operator-assisted peak detection.

Indicated, for illustration, on each histogram peak in FIG. 3 and FIG. 4 are what may be considered the starting and ending bins of each peak. Two peaks 31 and 35 are shown in FIG. 3. The starting bin 30 for peak 31 is bin number 65, and the ending bin 32 for peak 31 is bin number 107. The starting bin 34 for peak 35 is bin number 193, and the ending bin 36 for peak 35 is bin number 225. Three peaks 41, 44, and 47 are shown in FIG. 4. The starting bin 40 for peak 41 is bin number 60, and the ending bin 42 for peak 41 is bin number 100. The starting bin 43 for peak 44 is bin number 125, and the ending bin 45 for peak 44 is 180. The starting bin 46 for peak 47 is bin number 190, and the ending bin 48 for peak 47 is bin number 230.

In some embodiments, the aggregate peak information formed at step 54 may be a page peak counter. The page peak counter may be a histogram with the same bins as those in the segment histograms. If a bin in a segment histogram is detected as part of a peak in that histogram, then the corresponding bin in the page peak counter is incremented. Thus, the page peak counter accumulates the occurrence of a bin as part of a peak in a segment histogram.

After the peak information in the segment histogram shown in FIG. 3 is aggregated, bins 65-107 and bins 193-225 in the page peak counter are increased by one count each relative to the accumulated value in the bins prior to the aggregation of the peak information of the segment histogram shown in FIG. 3. After the peak information in the segment histogram shown in FIG. 4 is aggregated, bins 60-100, bins 125-180, and bins 190-230 are increased by one count each relative to the accumulated value in the bins prior to the aggregation of the peak information of the segment histogram shown in FIG. 4. Therefore, after the aggregation of the peak information in both segment histograms, the following bins in the page peak counter have been incremented by one count: bins 60-64, bins 101-107, bins 125-180, bins 190-192, and bins 226-230. And the following bins have been incremented by two counts: bins 65-100 and bins 190-225.

In this exemplary embodiment, step 55, the peak regions in the page peak counter may be normalized by the percentage of pixels in the input image 50 with a pixel value in the range of the peak, that is, values between the starting and ending bin values for that peak. In some embodiments, if a peak contains too few pixels, the region corresponding to that peak occurrence may be deemed insignificant. In some embodiments, the regions of occurrence of the peaks in the page feature histogram may correspond to image characteristics. These image characteristics may be, but are not limited to, the color of uniform-color regions of the input image 50, the luminance of uniform-luminance regions of the input image 50, the color of large text regions in the input image 50, the luminance of large text regions in the input image.

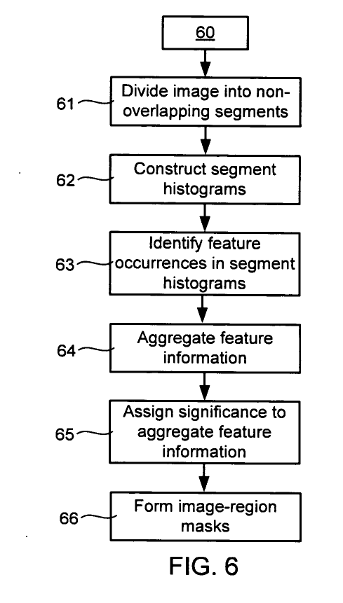

FIG. 6 shows embodiments of the present invention that may be used to identify regions in a digital image. An input image 60 is divided, at step 61, into non-overlapping image segments.

Image formation and region shapes may be as discussed with respect to embodiments described above.

In the embodiments shown in FIG. 6, division of the input image 60 into non-overlapping image segments, step 61, is followed by the construction of segment histograms, step 62, one segment histogram may be formed for each of the image segments or for some subset of the image segments. If the image segments are strips of the input image 60, a segment histogram may be referred to as a strip histogram. If the image segments are blocks of the input image 60, a segment histogram may be referred to as a block histogram.

In some embodiments of the method shown by FIG. 6, the segment histograms constructed at step 62, may each be one-dimensional histograms. Each bin in a segment histogram may show the number of pixels occurring in the corresponding image segment for which the pixels have the characteristic represented by the bin. For embodiments in which the input image 60 is a luminance image, the histogram bins may correspond to luminance values, and, in such embodiments, the histogram for a particular segment would reflect how many times a luminance value occurs in the image segment. In other embodiments of the method shown by FIG. 6, the segment histograms constructed at step 62, may be multi-dimensional histograms where the dimensions may correspond to some combinations of dimensions of a multi-dimensional input image 60.

Occurrences of features in each of the segment histograms may be identified at the next step, step 63, and the feature information from the segment histograms may be aggregated to form aggregate feature information at step 64. A significance value may be assigned to portions of the aggregate feature information at step 65. In some embodiments, image characteristics may be determined from the aggregate feature information. In some embodiments, image characteristics may be determined from the aggregate feature information in conjunction with the significance values.

In some embodiments of the method shown by FIG. 6, the feature occurrences identified in step 63, may be identified by a starting bin and an ending bin, in the histogram, between which the feature occurs. This range of bins may be referred to as the feature range or region of occurrence of the feature. Aggregation of the feature information at step 64 may comprise, in some embodiments, a page feature counter. In some embodiments, the page feature counter may be in the form of a page feature histogram. The page feature histogram may have bins corresponding to the bins of the segment histograms, wherein the bin counts in the page feature histogram may increment when the bin is part of a feature in a segment histogram. In such embodiments, the page feature histogram reflects the number of times a bin occurs in a feature in the segment histograms.

In some embodiments of the method shown by FIG. 6, a feature range in the page feature histogram may be assigned a significance value, step 65. The significance value for a feature range of a feature in the page feature histogram may be, in some embodiments, a measure of the number of pixels in the image occurring within the histogram bins included in the feature range. In some embodiments, the measure of the number of pixels may be a percentage. In some embodiments, the percentage may be determined by the page histogram which, in some embodiments, may be constructed through the accumulation of the segment histograms.

In some embodiments of the method shown in FIG. 6, a feature range of a feature in the page feature histogram may be modified based on its significance value. In some embodiments, the modification may be the normalization of the feature region in the page feature histogram. In some embodiments, if an occurrence of a feature contains too few pixels, the region corresponding to that feature occurrence may be deemed insignificant. In some embodiments, the regions of occurrence of the features in the page feature histogram may correspond to image characteristics. In some embodiments, the image characteristics may be, but are not limited to, the color of uniform-color regions of the input image 60, the luminance of uniform-luminance regions of the input image 60, the color of large text regions in the input image 60, the luminance of large text regions in the input image.

In some embodiments of the invention, image region masks may be formed, step 66. In these embodiments, the starting and ending bins of each occurrence of a feature in the page feature histogram may be determined to indicate the range of pixel values belonging to a region. In some embodiments, if the region corresponding to that feature occurrence was deemed insignificant, then a region mask may not be formed for that insignificant region. In some embodiments of the invention, the region mask is a binary image of the input image 60 with pixels in the range of values belonging to the region masked.

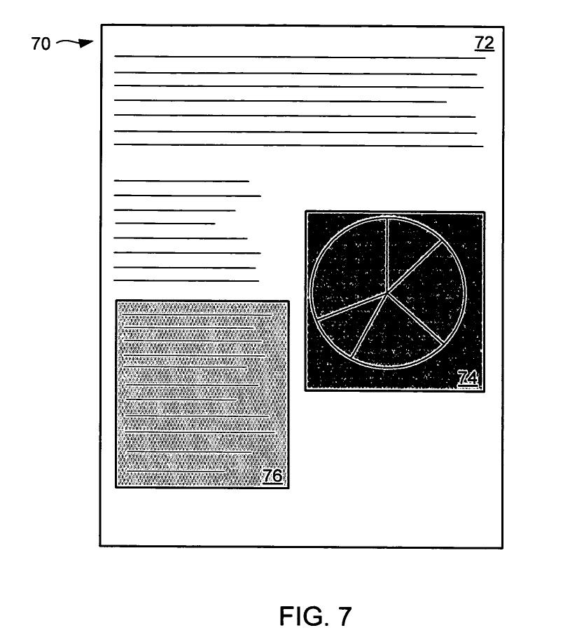

Some embodiments of the present invention detect regions of uniform color in an image. Page background, which is typically the color of the stock on which a scanned document is printed, is often removed and not reproduced in the enhanced, output image. Local background regions, however, should be enhanced and maintained in the output image. Accurate detection of both page and local background regions in an image is critical in many compression processes. Both page and local background regions are often regions of uniform color in the digital image. FIG. 7 shows a document image 70 with a page background region 72 and two regions of local background 74 and 76. The page background region 72 is of one color, and the two regions of local background 74 and 76 are of two different colors.

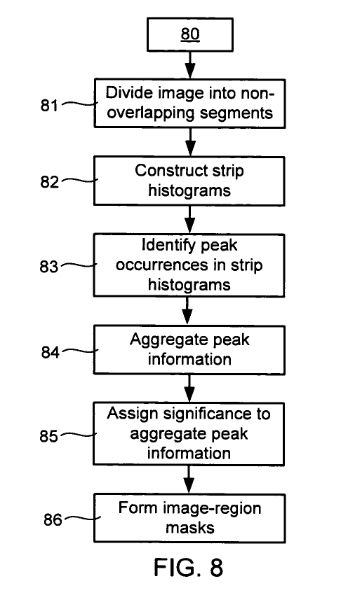

FIG. 8 shows an exemplary embodiment of the present invention in which regions of uniform color in an image are identified. The input image 80 may be a luminance image. The input image 80 may be divided into strips, step 81. For each strip, a strip histogram may be constructed, step 82. A strip histogram may comprise bins corresponding to range of luminance values in the input image 80. Each bin in a strip histogram accumulates the number of pixels in the strip with luminance value to which the bin corresponds. Peaks may be identified in each strip histogram, step 83. The identification of each peak may comprise determination of a starting histogram bin and an ending histogram bin for the peak. The starting and ending bins for a peak may comprise the peak information.

The peak information from the strip histograms may be aggregated into a page peak counter, step 84. The page peak counter may comprise a page peak histogram. The page peak histogram has the same bins as the strip histograms. Each bin in the page peak histogram counts the frequency of occurrence of that bin number in a peak in the strip histograms. The peaks in the page peak histogram correspond to luminance values for which there may be uniform regions of the same luminance in the input image 80.

Each peak in the page peak histogram may be normalized by a significance value assigned to said peak, step 85. The significance value may be the number of image pixels, as a percentage of pixels in the image, with luminance value between and including the starting bin value and ending bin value for said peak. In some embodiments, if the height of a normalized peak falls below a threshold, the peak is deemed insignificant. In some embodiments, all peaks are considered significant.

A binary image region mask corresponding to a significant peak in the page peak histogram is formed at step 85 by generating a binary image of the same size as the input image 80. In the binary image, pixels corresponding to pixels in the input image 80 with luminance value in the input image 80 falling between, inclusively, the starting and ending luminance value of the peak, are considered part of the mask. The mask pixels in the binary image take value 1, and the non-mask pixels take value 0, or the mask pixels in the binary image take value 0, and the non-mask pixels take value 1.

In some embodiments, a single region mask may be formed in which all, or some portion, of significant regions are identified. A single region mask may comprise an indexed image in which each index corresponds to a region.

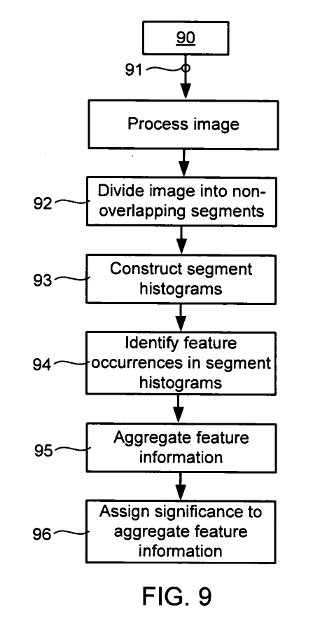

FIG. 9 shows embodiments of the invention in which the image 91, referred to as the preprocessed image, is derived from another image 90, referred to as the input image. In the embodiment described by FIG. 9, the preprocessed image 91 may be an image where a pixel value represents the direction of an edge at the corresponding pixel in the input image 90. The bins in a segment histogram may correspond to edge direction with a histogram bin reserved for “no edge.” In this embodiment, peaks in a segment histogram refer to pixels in the preprocessed image 91 with similar values which in turn correspond to pixels in the input image 90 that occur on edges of similar direction. A preprocessed image may be an image processed by any image processing technique for example edge detection, including both strength and direction, color or luminance saturation detection, or any enhancement or reconstruction technique.

Preferred embodiments of the present invention are described using non-overlapping image segments. Alternate embodiments of the present invention may use overlapping image segments.

The terms and expressions which have been employed in the foregoing specification are used therein as terms of description and not of limitation, and there is no intention in the use of such terms and expressions of excluding equivalence of the features shown and described or portions thereof, it being recognized that the scope of the invention is defined and limited only by the claims which follow.

I claim:

1. A method for identifying characteristics in a digital image, said method comprising:
a. constructing a first segment histogram for a first segment of said image;
b. constructing a second segment histogram for a second segment of said image;
c. identifying any occurrences of a feature in said first segment histogram thereby generating first feature-occurrence information;
d. identifying any occurrences of a feature in said second segment histogram thereby generating second feature-occurrence information; and
e. aggregating said first feature-occurrence information and said second feature-occurrence information to form aggregate feature information.

2. The method of claim 1 said segment is a strip of said image.

3. The method of claim 1 said segment is a block of said image.

4. The method of claim 1 wherein said aggregate feature information comprises a page feature counter.

5. The method of claim 1 wherein said feature-occurrence information comprises a starting histogram bin and an ending histogram bin when said feature is identified to occur.

6. The method of claim 4 wherein said forming a page feature counter further comprises incrementing said page feature counter based on said first feature-occurrence information and said second feature-occurrence information.

7. The method of claim 1 further comprising assigning a significance value to portions of said aggregate feature information.

8. The method of claim 1 wherein said occurrence of a feature is the occurrence of a peak.

9. The method of claim 8 wherein said feature-occurrence information comprises a starting histogram bin for said occurrence of a peak and an ending histogram bin for said occurrence of a peak when said peak is identified.

10. An apparatus for identifying regions in a digital image, said apparatus comprising:
a. a segment histogram constructor for generating segment histograms of said image;
b. a feature identifier for identifying features in said segment histograms;
c. a feature-occurrence information generator for generating information describing said feature occurrences when said features are identified in said segment histograms; and
d. a feature-occurrence information aggregator for combining said feature-occurrence information for a multiplicity of segment histograms to form aggregate feature information.

11. The apparatus of claim 10 wherein said aggregator comprises a page feature counter.

12. The apparatus of claim 10 wherein said feature identifier comprises a peak detector.

13. The apparatus of claim 10 wherein said feature-occurrence information generator comprises determining a starting histogram bin and an ending histogram bin when said feature is identified to occur.

14. The apparatus of claim 11 wherein said page feature counter further comprises an incrementor wherein said incrementor increments said page feature counter based on said feature-occurrence information.

15. The apparatus of claim 10 further comprising a significance adjustor wherein said significance adjustor adjusts said aggregate feature information.

16. A method for generating region masks for a digital image, said method comprising:
a. constructing a first segment histogram for a first segment of said image;
b. constructing a second segment histogram for a second segment of said image;
c. identifying any occurrences of a feature in said first segment histogram thereby generating first feature-occurrence information;
d. identifying any occurrences of a feature in said second segment histogram thereby generating second feature-occurrence information;
e. aggregating said first feature-occurrence information and said second feature-occurrence information to form aggregate feature information;
f. adjusting said aggregate feature information according to a significance value to form adjusted aggregate feature information; and
g. generating a region mask said region mask depending on said adjusted aggregate feature information.

17. The method of claim 16 wherein said segment is a strip of said image.

18. The method of claim 16 wherein said segment is a block of said image.

19. The method of claim 16 wherein said occurrence of a feature is the occurrence of a peak.

20. The method of claim 16 wherein said aggregate feature information comprises a page feature counter.
